(19) United States
(12) Patent Application Publication
(10) Pub. No.: US 2026/0270796 A1
(43) Pub. Date: Sep. 10, 2026

(54) SYSTEM AND METHOD FOR DYNAMIC NETWORK COVERAGE AND RESOURCE ALLOCATION USING CONFIGURABLE ANTENNA SUBSYSTEMS

(71) Applicant: AT&T Intellectual Property I, L.P., Atlanta, GA (US)

(72) Inventors: Joseph Soryal, Glendale, NY (US); Venson Shaw, Kirkland, WA (US)

(73) Assignee: AT&T Intellectual Property I, L.P., Atlanta, GA (US)

(21) Appl. No.: 19/069,381

(22) Filed: Mar. 4, 2025

(51) Int. Cl. H04W 28/24; H04W 16/10; H04W 72/543

(52) U.S. Cl. CPC H04W 28/24; H04W 16/10; H04W 72/543

(57) ABSTRACT

Aspects of the subject disclosure may include, for example, dynamic network coverage and resource allocation using configurable modular subsystems. The technical problem addressed is the need for enhanced network capacity and coverage in urban environments where traditional infrastructure is insufficient. The solution involves an elongated module supporting structure having distributed configurable electronic modules disposed thereon that can be dynamically adjusted to meet mobile service requirements. The system includes a configuration generator configured to determine service requirements and to configure subgroups of the configurable electronic modules accordingly. This technology can be used to provide localized wireless coverage and/or optimize network performance in response to user demand and/or environmental conditions. The system can operate in the millimeter wavelength region, enhancing data transmission rates and network capacity. The primary use of this technology is in telecommunications, particularly in urban areas requiring high-speed, reliable wireless communication. Other embodiments are disclosed.

### FIELD OF THE DISCLOSURE

The subject disclosure relates to system and method for dynamic network coverage and resource allocation using configurable antenna subsystems.

### BACKGROUND

In the rapidly evolving landscape of telecommunications, the demand for high-speed, reliable wireless communication continues to grow. As mobile data usage increases, there is a pressing need to enhance network capacity and coverage, particularly in urban environments where traditional infrastructure may be insufficient. Certain advanced technologies offer promising solutions due to their potential for high data rates and large bandwidth. However, these signals are naturally limited by their short range and susceptibility to physical obstructions, which can significantly hinder their effectiveness in providing consistent coverage.

Millimeter wave (mmWave) cellular technology represents a significant advancement in wireless communication, offering the potential for ultra-high-speed data transmission and increased network capacity. Operating in the frequency range of 30 GHz to 300 GHz, mmWave technology can support data rates that are orders of magnitude higher than those achievable with traditional cellular frequencies. This capability is particularly advantageous in densely populated urban areas, where the demand for data-intensive applications, such as high-definition video streaming and augmented reality, is rapidly increasing. However, the deployment of mmWave technology is not without challenges. The high-frequency signals are inherently limited by their short range and are highly susceptible to attenuation from physical obstructions such as buildings, foliage, and even weather conditions. These limitations necessitate the development of innovative network architectures and deployment strategies to ensure reliable coverage and connectivity. As the telecommunications industry continues to explore the potential of mmWave technology, there is a critical need for solutions that can effectively integrate this technology into existing network infrastructures, thereby maximizing its benefits while mitigating its inherent challenges.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communication system in accordance with various aspects described herein.

FIG. 2A is a block diagram illustrating an example, non-limiting embodiment of an adaptive wireless access system functioning within the communication system of FIG. 1 in accordance with various aspects described herein.

FIG. 2B is a block diagram illustrating an example, non-limiting embodiment of a configurable subsystem functioning within the adaptive wireless access system of FIG. 2A in accordance with various aspects described herein.

FIG. 2C is a block diagram illustrating an example, non-limiting embodiment of a distributed antenna assembly functioning within the adaptive wireless access system of FIG. 2A in accordance with various aspects described herein.

FIG. 2D is a block diagram illustrating an example, non-limiting embodiment of a configurable surface system functioning within the communication system of FIG. 1 in accordance with various aspects described herein.

FIG. 2E is a block diagram illustrating an example, non-limiting embodiment of an interface module functioning within the adaptive wireless access system of FIG. 2A in accordance with various aspects described herein.

FIG. 2F is a block diagram illustrating an example, non-limiting embodiment of a power-deriving interface system functioning within the adaptive wireless access system of FIG. 2A in accordance with various aspects described herein.

FIG. 2G is a block diagram illustrating an example, non-limiting embodiment of a distributed, configurable surface assembly architecture functioning within the communication system of FIG. 1 in accordance with various aspects described herein.

FIG. 2H is a block diagram illustrating an example, non-limiting embodiment of a distributed, configurable surface assembly architecture functioning within the communication system of FIG. 1 in accordance with various aspects described herein.

FIG. 2I is a block diagram illustrating an example, non-limiting embodiment of a mobile, configurable surface assembly architecture functioning within the communication system of FIG. 1 in accordance with various aspects described herein.

FIG. 2J is a block diagram illustrating an example, non-limiting embodiment of a distributed, configurable surface assembly architecture functioning within the communication system of FIG. 1 in accordance with various aspects described herein.

FIG. 2K is a block diagram illustrating an example, non-limiting embodiment of a steerable distributed antenna system functioning within the communication system of FIG. 1 in accordance with various aspects described herein.

FIG. 2L is a block diagram illustrating an example, non-limiting embodiment of a distributed, adaptive surface antenna system functioning within the communication system of FIG. 1 in accordance with various aspects described herein.

FIG. 2M is a block diagram illustrating an example, non-limiting embodiment of a multi-feed, distributed antenna system functioning within the communication system of FIG. 1 in accordance with various aspects described herein.

FIG. 2N depicts an illustrative embodiment of a distributed surface assembly configuration process in accordance with various aspects described herein.

FIG. 2O depicts an illustrative embodiment of a distributed surface assembly configuration process in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for dynamic network coverage and resource allocation, utilizing an elongated structure supporting a group of configurable electronic modules that are dynamically adjustable by a module configuration generator to meet mobile service requirements, thereby optimizing network performance in response to user demand and environmental conditions. Other embodiments are described in the subject disclosure.

One or more aspects of the subject disclosure include a device including an elongated module supporting structure, multiple configurable electronic modules distributed along a length of the elongated module supporting structure and a module configuration generator in communication with the configurable electronic modules. The module configuration generator includes a processing system having a processor and a memory that stores executable instructions thereon that, when executed by the processing system, cause the processing system to perform operations. The operations include determining a first mobile service requirement, determining a first location along the length of the elongated module support structure according to the first mobile service requirement, identifying a first electronic module subgroup of the plurality of configurable electronic modules according to the first location, and configuring the first electronic module subgroup according to the first mobile service requirement.

One or more aspects of the subject disclosure includes a process for providing dynamic network coverage and resource allocation. The process includes determining by a processing system including a processor, a first communication requirement. According to the process, a first region is located, by the processing system and according to the first communication requirement, along a length of an elongated module support structure, which includes multiple configurable electronic modules. A first electronic module subgroup of the multiple configurable electronic modules is selecting, by the processing system, according to the first region. Further, according to the process, the first electronic module subgroup is configured, by the processing system, according to the first communication requirement.

One or more aspects of the subject disclosure include a non-transitory machine-readable medium, including executable instructions that, when executed by a processing system including a processor, facilitate performance of operations. The operations include determining a communication requirement and determining a first location along a length of an extended configurable processing system according to the communication requirement. The extended configurable processing system includes a physical support comprising a plurality of configurable modules coupled thereto. A first configurable module subgroup of the plurality of configurable modules is identified according to the first location, and the first configurable module subgroup is configured according to the communication requirement.

Current approaches to extending coverage often involve deploying additional infrastructure, which can be costly and complex to implement. These methods may also face challenges in terms of scalability and integration with existing network systems. As a result, there is a significant need for innovative solutions that can efficiently expand coverage while minimizing deployment costs and complexity. Such solutions would ideally leverage existing infrastructure to provide a more seamless and adaptable network experience, addressing the limitations of current technologies and meeting the growing demands of modern wireless communication.

A smart, on-demand wireless-wireline converged infrastructure represents an innovative approach to integrating wireless and wireline technologies to enhance network performance and service delivery. This convergence allows for seamless communication and data transfer across different network types, leveraging the strengths of both wireless and wireline systems. The smart aspect of this infrastructure refers to its ability to dynamically adapt to changing network conditions and user demands, by adapting and, in at least some embodiments, optimizing resource allocation to ensuring efficient and reliable service delivery. On-demand capabilities enable the network to scale and/or configure itself in real-time, providing the necessary bandwidth and connectivity where and when it is needed most. This approach not only improves the overall user experience by offering consistent and reliable connectivity but also reduces operational costs by maximizing the use of existing infrastructure. By integrating wireless and wireline networks, service providers can offer a more robust and flexible network solution that meets the growing demands of modern mobile communication.

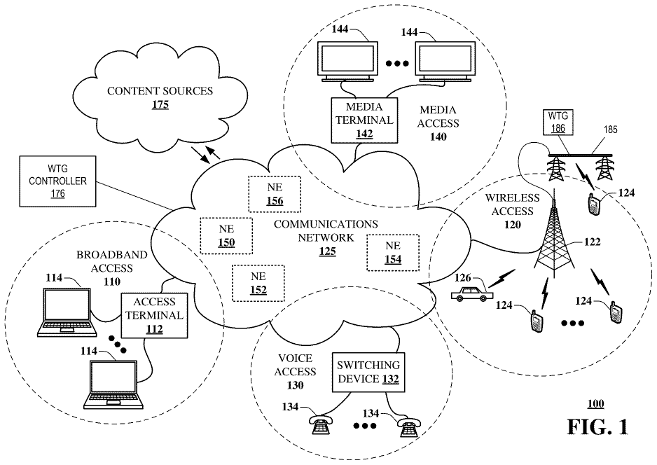

Referring now to FIG. 1, a block diagram is shown illustrating an example, non-limiting embodiment of a system 100 in accordance with various aspects described herein. For example, the communication system 100 can facilitate in whole or in part, utilization of an elongated structure supporting a group of configurable electronic modules that are dynamically configurable by a module configuration generator to support dynamic network coverage and resource allocation to meet mobile service requirements, thereby optimizing network performance in response to user demand and environmental conditions. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc., for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc., can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

In at least some embodiments, the communication system includes one or more elongated, configurable module systems, physically supported by existing structures and configured to enhance and/or otherwise optimizing network performance in response to user demand and environmental conditions. According to the illustrative embodiment, the wireless access network 120 includes an elongated, configurable module system 185 supported by an existing aerial cable, e.g., a power cable and/or a telecommunications cable. The elongated, configurable module system 185 includes multiple configurable electronic modules distributed along a length of the example aerial cable. The example elongated, configurable module system 185 also includes at least one module configuration generator 186 in communication with the configurable electronic modules. In at least some embodiments, the module configuration generator 186 can include a processing system having a processor and a memory that stores executable instructions thereon that, when executed by the processing system, cause the processing system to perform operations. The operations include determining a first mobile service requirement, determining a first location along the length of the elongated module support structure according to the first mobile service requirement, identifying a first electronic module subgroup of the plurality of configurable electronic modules according to the first location, and configuring the first electronic module subgroup according to the first mobile service requirement.

By way of non-limiting example, the mobile service requirement may be related to demand, e.g., allocating and/or otherwise distributing and/or otherwise redistributing wireless coverage regions by configuring and/or reconfiguring configurable antenna modules along the length of the elongated module support structure. Alternatively, or in addition, the mobile service requirement may be related to a radio access network (RAN) function, a user plane function, and/or a mobile core network function, e.g., including any of the example wireless technologies discussed herein and/or otherwise generally known. Although the illustrative example includes an elongate, configurable module system 185 in the wireless access network 120, it is understood that alternatively, or in addition, other distributed, configurable module systems can be provided in one or more of the other networks, e.g., including the broadband access network 110, the voice access network, the media access network 140 and/or the communications network 125.

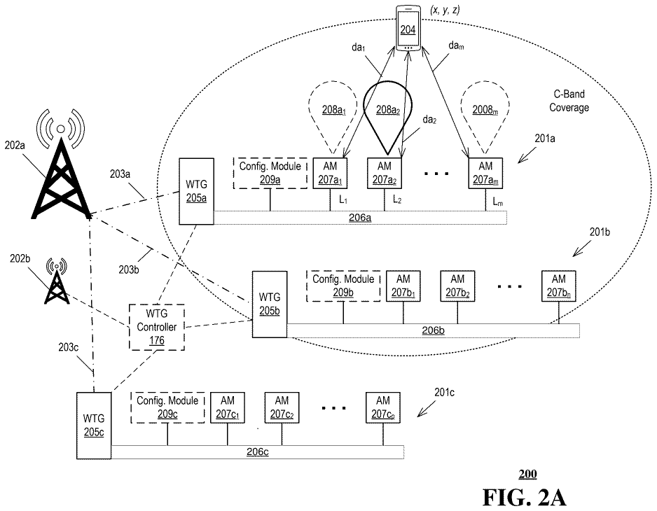

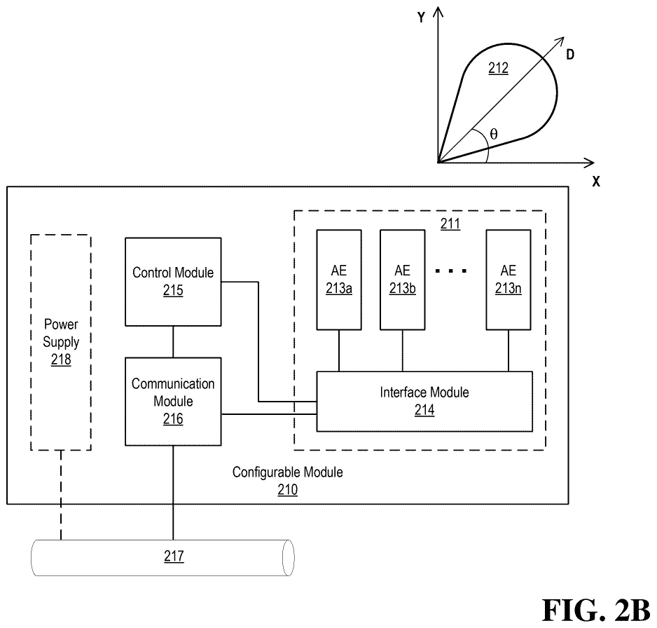

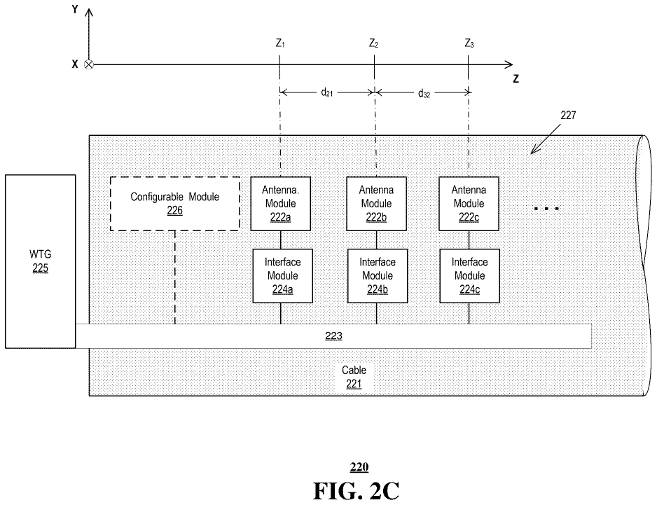

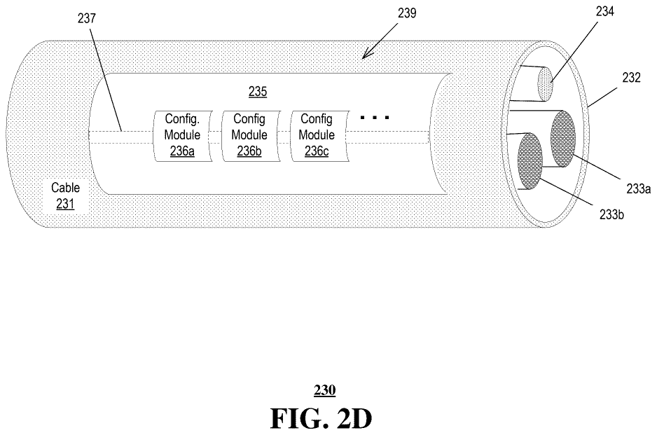

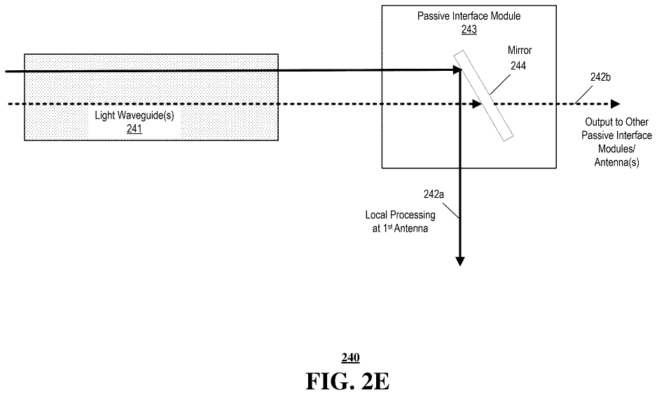

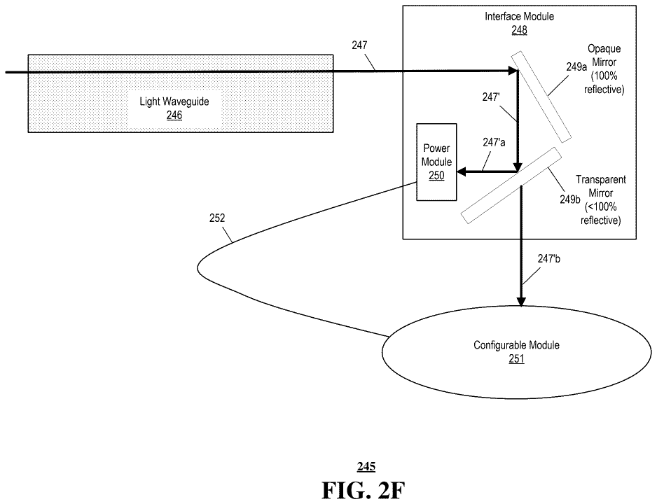

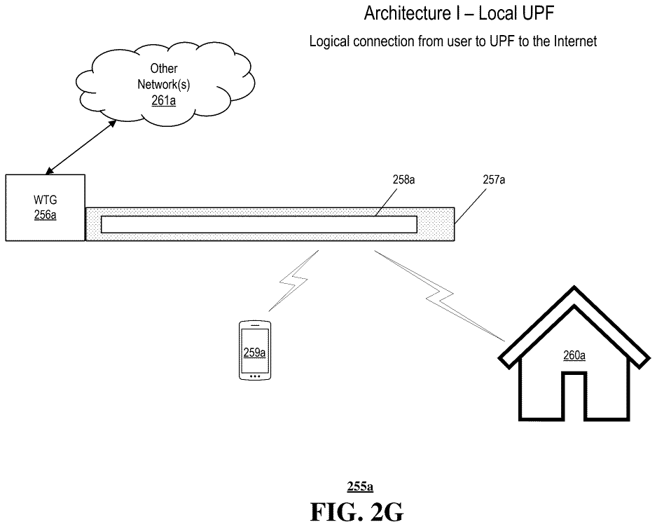

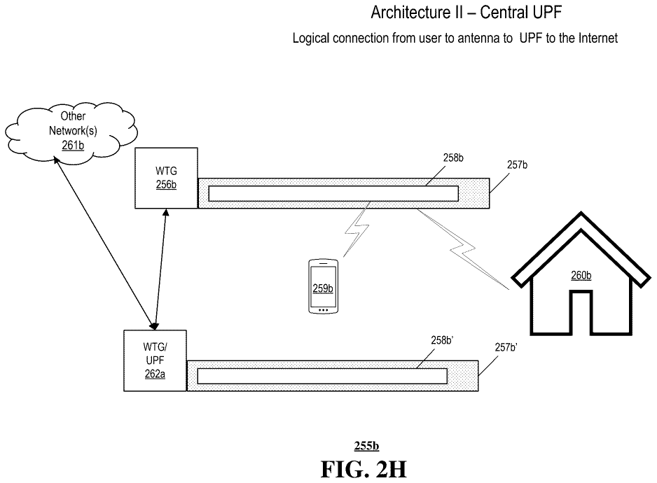

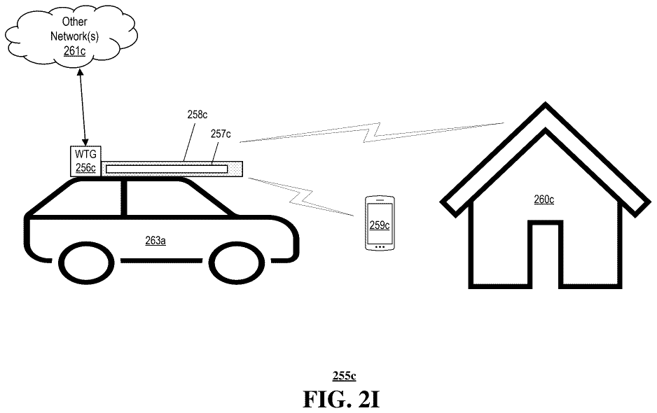

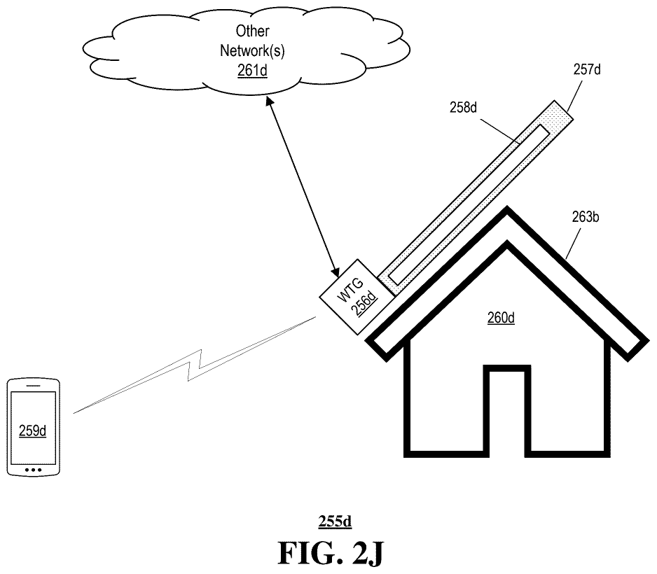

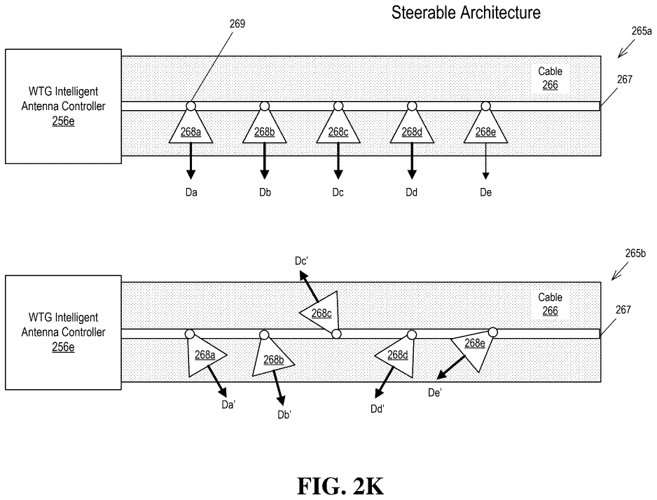

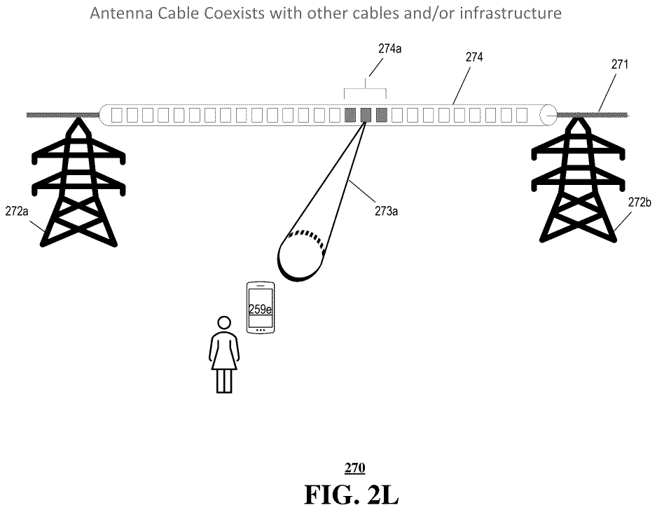

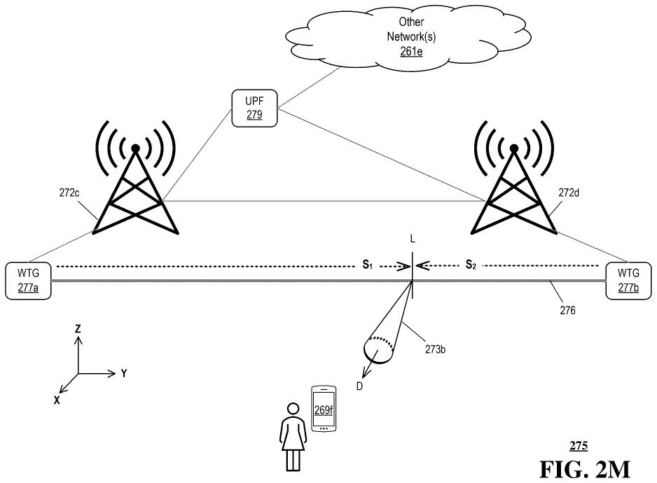

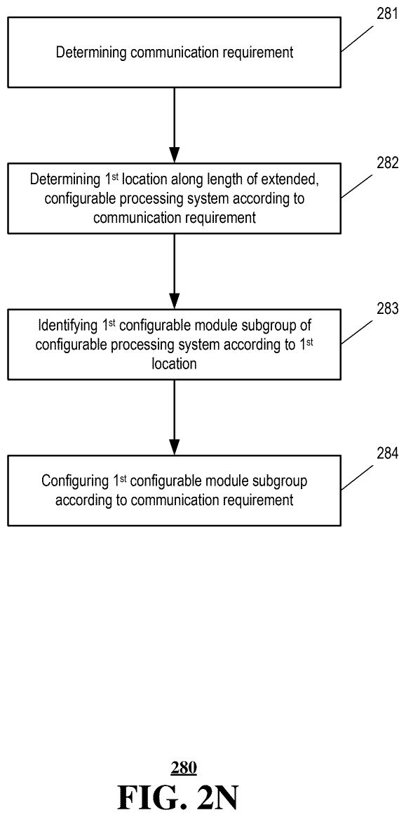

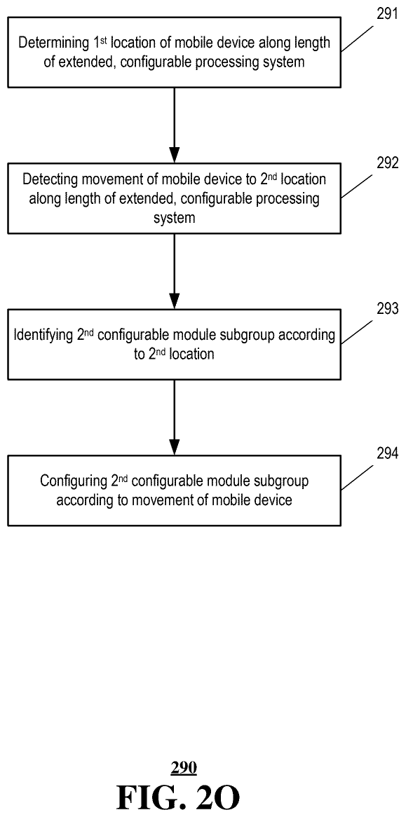

FIG. 2A is a block diagram illustrating an example, non-limiting embodiment of an adaptive wireless access system 200 functioning within the communication system 100 of FIG. 1 in accordance with various aspects described herein. According to the illustrative embodiment, the adaptive wireless access system 200 is composed of several key components that contribute to the system's ability to provide dynamic network coverage and/or resource allocation. In particular, the adaptive wireless access system 200 includes a first distributed, configurable surface assembly 201a at a first location, a second distributed, configurable surface assembly 201b at a second location and possibly others, such as a third distributed, configurable surface assembly 201c at a third location.

The first configurable surface assembly 201a, includes one or more configurable modules 209a, coupled to and/or otherwise integrated with a smart surface, e.g., as may be applied to an existing structure, such as a cable, a tower, a building, a vehicle, and the like. In at least some embodiments, the first configurable surface assembly 201a includes a control module, e.g., a wireless terminal generator (WTG) 205a that can be operable to coordinate a configuration of the configurable modules 209a, a reconfiguration of the configurable modules 209a and/or interconnectivity of one or more of the configurable modules 209a with other devices and/or systems, In at least some embodiments, the WTG 205a and the configurable modules 209a are in communication with a first signal path 206a facilitating communications, sensing and/or controls therebetween. In at least some embodiments, the configurable modules 209a can be dynamically adjusted to function as antennas, baseband units, or other network components, providing flexibility in network configuration.

According to the illustrative embodiment, at least some of the configurable modules 209a have been configured as a first group of antenna modules 207a₁, 207a₂, . . . 207aₙ, generally 207a. The first group of antenna modules 207a provide wireless coverage and are capable of adjusting their configuration to optimize signal reception and transmission based on one or more of operational requirements, network conditions, environmental conditions, user demand and/or user location.

In at least some embodiments, the second distributed, configurable surface assembly 201b includes one or more configurable modules 209b, with at least some of these modules configured as a second group of antenna modules 207b₁, 207b₂, . . . 207bₘ, generally 207b. The second group of antenna modules 207b, as well as any other configurable modules 209b are in communication with each other and/or with a second WTG 205b via a second signal path 206b. Likewise, the third distributed, configurable surface assembly 201c includes one or more configurable modules 209c, with at least some of these modules configured as a third group of antenna modules 207c₁, 207c₂, . . . 207cₚ, generally 207c. The third group of antenna modules 207c, as well as any other configurable modules 209c are in communication with each other and/or with a third WTG 205c via a third signal path 206c.

According to the illustrative embodiment, the first distributed, configurable surface assembly 201a, is in communication with a first macro cell terminal 202a via a first backhaul link 203a. Likewise, the second distributed, configurable surface assembly 201b, is in communication with the first macro cell terminal 202a via a second backhaul link 203b and the third distributed, configurable surface assembly 201c, is in communication with the first macro cell terminal 202a via a third backhaul link 203c.

In at least some embodiments, the adaptive wireless access system 200 includes a WTG controller 176 in communication with one or more of the first, second and third WTGs 205a, 205b, 205c, generally 205. The WTG controller 176 can be configured to monitor network conditions, to evaluate communication requirements and/or to coordinate configurations and/or reconfigurations of one or more of the configurable surface assemblies 201a, 201b, 201c, generally 201, as may be necessary to deliver, and/or otherwise maintain delivery of network services to user equipment (UE) 204 as may be distributed over a relatively large geographic area and/or mobile within the geographic area.

In at least some embodiments, the adaptive wireless access system 200 is configured to provide a localized wireless coverage to one or more UEs 104. For example, the adaptive wireless access system 200 may be configured to provide wireless coverage in the millimeter and/or the terahertz frequency ranges, in which radio wave propagation may be limited to a coverage area that is less than an extended range or are spanned by any one or more of the configurable surface assemblies 201. Accordingly, the configurable surface assemblies may be configured to provide selected geographic coverage based on a position of the 204, e.g., at a location (x, y, z), which may include a location relative to some other geographic structure, such as the configurable surface assembly 201 and/or a geolocation.

By way of example, the first configurable surface assembly 201a is configured to provide an adaptable, localized service coverage 208a₂ that may be adaptable based on one or more of movement of the UE 204, changing environmental conditions, e.g., interference, fading, signal blockage, and the like to guides the system's adaptive response to ensure optimal coverage for delivery of mobile services to the UE 204. In this example, the each of the antenna modules 207a₁, 207a₂ . . . 207ₘ, is configured to provide coverage in a respective localized coverage region 208a₁, 208a₂ . . . 208ₘ, generally 208. In at least some embodiments, a subset of the available coverage regions 208 may be activated to provide localized coverage based on the location and/or movement of the UE 204. For example, the adaptive wireless access system 200 may be configured to identify a current location of a UE 204 and/or a predicted location of a mobile UE 204, and responsive to the current and/or predicted location, activate one or more of the antenna modules 207 proximate to the UE 204, while deactivating and/or otherwise disassociating other antenna modules 207 of the configurable surface assemblies 201a. In some embodiments in which the UE 204 is operable within a macro cell coverage region of the first macro cell terminal 202a, a location and/or mobility information related to the UE 204 may be provided by the first macro cell terminal 202a to one or more of the configurable surface assemblies.

For example, in situations in which more than one of the configurable surface assemblies 201a, 210b may reside at least partially within the macro cell coverage region of the first macro cell terminal 202a, the first macro cell terminal 202a may be preconfigured with and/or otherwise access information identifying identities and/or parameters of the configurable surface assemblies 201a, 201b. This information may include locations of the configurable surface assemblies 201a, 201b, sizes, e.g., lengths, and/or orientations of the configurable surface assemblies, operable frequency ranges, supported communication protocols, associated network operators and/or owners of the configurable surface assemblies 201a, 201b, and the like. The first macro cell terminal 202a may identify the location of the UE 204 and select at least one of the first and second configurable surface assemblies 201a, 201b, e.g., based on proximity, availability, performance compatibility, and so on. The first macro cell terminal 202a may determine the location of the UE 204, e.g., based on a self-reporting from a GPS receiver of the UE 204 and/or based on location as may be determined by a mobile network operator, e.g., based on signal strengths and/or signal propagation delays to one or more of the macro cell terminals 202a, 202b.

In at least some embodiments, the configurable surface assemblies 201a is configured to adjust the antenna beam/directivities 208a, 208b to focus coverage provided by the antenna modules 207, which can be adjusted to improve coverage and signal strength. The interconnections between these components enable the system to dynamically manage network resources and provide efficient wireless communication services. The WTGs 205, controlled by the WTG controller 176, work in conjunction with the configurable and antenna modules to adapt to user location and network demand, ensuring targeted and reliable coverage. Overall, the example adaptive wireless access system 200 represents a sophisticated network architecture that leverages configurable components and dynamic control to deliver adaptive and efficient wireless communication services.

FIG. 2B is a block diagram illustrating an example, non-limiting embodiment of a configurable module 210 functioning within the adaptive wireless access system 200 of FIG. 2A in accordance with various aspects described herein. The configurable module 210 is designed to enhance network functionality through its various components, each serving a specific purpose that can be controlled, combined, configured, and/or otherwise reconfigured as beneficial to an intended application. For example, in an antenna application, the configurable module 210 can be configured provide controllable antenna configurations that can operate to dynamically optimize signal reception and transmission.

According to the illustrative example, the configurable module includes a sensor module 211, a control module 215, a communication module 216 and optionally, in at least some embodiments, a power supply 218 (shown in phantom). The sensor module 211 can include one or more configurable components, such as configurable sensor elements 213a, 213b, . . . , 213n, generally 213, in communication with an interface module 214. It is understood that in at least some embodiments, the configurable module 210 can be in communication with a signal carrier 217, e.g., a signal and/or control cable. The configurable 210 can be part of a larger system of other modules, such as other similar configurable modules 210 that may be in further communication with other devices and/or systems, e.g., via the signal carrier 217.

In at least some embodiments, one or more of the sensor elements 213 are antenna elements. Antenna elements can include circuits, conductive traces, apertures, and the like that may be selectively activated, deactivated, combined, and/or otherwise arranged according to a particular operational requirement, e.g., an antenna coverage region, gain, directivity and/or pattern. An example antenna beam/directivity 212 is illustrated represents a directional focus of the sensor module 211. In at least some embodiments, the interface module 214 includes controllable switches that can be activated/deactivated to reconfigure the sensor elements 213. The switches can facilitates a dynamic reconfiguration of the sensor elements 213, allowing for changes in the antenna's operational state and connectivity. Accordingly, the sensor elements 213 can be adjusted, as described, to improve coverage and signal strength based on user demand and environmental conditions, e.g., forming different beam patterns and directivity angles.

The control module 215 is operable to control one or more components of the configurable module 210, e.g., managing the configuration and operation of the sensor module 211, one or more of the sensor elements 213, and/or the interface module 214 based on input from the network and user requirements. The communication module 216 can be configured to facilitate seamless communication between the sensor module 211 and other network components, enabling data exchange and coordination.

In some embodiments, the sensor elements 213 are similar, e.g., representing segments of an antenna structure, with an understanding that the sizes, shapes and/or locations of the sensor elements 213 may differ even though they are related to a common function, e.g., transmission and/or reception of wireless signals. Alternatively, or in addition, at least some of the sensor elements 213 may differ within the same sensor module 211. For example, a first subgroup of sensor elements 213 may be configured for operation in one frequency band, while another subgroup of sensor elements 213 may be configured for operation in another frequency band, the different operable frequency bands requiring substantially different types of sensor elements 213. In at least some embodiments, one or more of the sensor elements 213 can include environmental sensors, such as thermal sensors, moisture sensors, salinity sensors, vibration sensors, wind sensors, light sensors, and so on.

Overall, FIG. 2B illustrates a sophisticated and adaptable sensor subsystem that enhances network performance through its configurable components and dynamic operation.

FIG. 2C is a block diagram illustrating an example, non-limiting embodiment of a distributed antenna assembly 220 including a continuous antenna layer 227 functioning within the adaptive wireless access system 200 of FIG. 2A in accordance with various aspects described herein. It is understood that the continuous antenna layer 227 can include a configurable part of an adaptive wireless access system. This assembly is designed to provide flexible and efficient network coverage through its various components, each serving a specific function.

The continuous antenna layer 227 represents an integrated layer of antennas within a surface assembly, designed to provide consistent and adaptable network coverage. In at least some embodiments, the continuous antenna layer 220 includes multiple antenna modules 222a, 222b, 222c, generally 222, one or more interface modules 224a, 224b, 224c, generally 224, and at least one wireless terminal generator (WTG) 225. In at least some embodiments, the continuous antenna layer 220 may optionally include one or more other configurable modules 226 (shown in phantom). The WTG 225 can be configured to function as a control unit for the continuous antenna layer 220, e.g., managing one or more of activation, configuration, and/or communications of the antenna modules 222, the interface modules 224 and any other configurable modules 226 that may be available. According to the illustrative example, the continuous antenna layer 220 also includes at least one signal path 223. The signal path may be in communication with one or more of the antenna modules 222, one or more of the interface modules 224, one or more of any other configurable modules 226 that may be available and/or the WTG 225. In at least some embodiments, the continuous antenna layer 220 may include one or more other configurable modules 226 that may be configurable to support configuration, control and/or operation of the continuous antenna layer 222. in communication with multiple.

It is envisioned that the antenna modules 222 can be responsible for providing wireless coverage and can be configured to optimize signal reception and transmission based on environmental conditions and user demand. The antenna modules may operate individually and/or collectively in one or more groups, e.g., to provide, when activated, respective coverage regions that in at least some embodiments, may be relatively localized to a location of the active antenna module(s) 222. The antenna modules 222 may include surface patch antennas, wire antennas, aperture antennas, leaky waveguide antennas, and the like. The antenna modules 222 may be configured as monopole antennas, dipole antennas, slot antennas, e.g., open waveguide antennas, horn antennas. In at least some embodiments, the antenna modules 222 may be configured with reflector elements and/or director elements that may operate to affect operation of the antenna element, e.g., providing a gain, directivity, beamwidth, null and the like. Without limitation, in some embodiments, all of the antenna modules 222 are similar and/or identical. Alternatively, in at least some embodiments, at least some of the antenna modules 222 may be distinguishable from others. For example, the continuous antenna layer 227 may include alternating antenna modules 222 of different types, and/or distinguishable groups of antenna modules 222 of similar types that can differ according to group.

It is understood that the interface modules 224 can be configured to facilitate communication between the antenna modules and other network components, ensuring seamless data exchange and coordination. In at least some embodiments, the interface modules 224 are operable to control, direct and/or otherwise manage communications between the antenna modules 222 and one or more of the signal path 223, other antenna modules 222, the WTG 225 and/or any other configurable modules 226.

Any configurable modules 226 that may be provided can be dynamically adjusted to function as one or more of an antenna module 222, an interface module 224, and/or according to some other function, such as a baseband unit or any other network component, e.g., a switch, a router, a storage device, providing flexibility in network configuration. Alternatively, or in addition, the configurable module 226 may include one or more signal processing functions, such as amplification, filtering, analog-digital conversions and so on.

In some embodiments, the signal path 223 includes an electrical circuit, such as a wire, or a group of wires that, in at least some embodiments, may operate as an signal path 223. Alternatively, or in addition, the signal path 223 can include a transmission line and/or a waveguide. The transmission line may include electrically conductive twisted pair, strip line, microstrip, coaxial cable and/or a hollow waveguide. In at least some embodiments, the transmission line may include a dielectric waveguide, such as an optical fiber. It is envisioned that the signal path 223 can be configured to serve as a communication backbone within the continuous antenna layer 227, interconnecting the various modules and enabling an efficient transfer of data.

It is envisioned that in at least some embodiments, the continuous antenna layer 227 may be attached to and/or otherwise supported by another structure, such as a cable, a tower, a building, a roadway, a bridge, a guardrail, and so on. According to the illustrative embodiment, a cable 221 provides a physical infrastructure for the surface assembly, supporting the deployment of the configurable modules and antenna modules across different environments. The cable 221 may include an aerial cable, e.g., suspended from supporting structures, such as utility poles and/or towers (not shown). Alternatively, or in addition, the cable 221 may include a subterranean cable as may be buried beneath the ground and/or installed in a conduit or channel beneath the ground.

It is envisioned that in at least some embodiments, the antenna modules 222 may be installed in an elongated manner, e.g., according to a linear pattern that may extend along a cable 221. Alternatively, or in addition, the antenna modules 222 may be installed according to some other arrangement, such as a rectangular pattern and/or some other conformal pattern that may conform to a supporting structure. According to the illustrative example, the antenna modules 222 are configured in a linear pattern extending along the cable 221, with each antenna module 222 located at a respective location along the cable 221 and separated from adjacent antenna modules by respective separation distances. In some embodiments, the antenna modules 222 may be installed according to a regular arrangement in which the spacing between adjacent antenna modules 222 is uniform. Alternatively, the antenna modules 222 may be installed according to some other arrangement in which the spacing between adjacent antenna modules 222 may be nonuniform, e.g., according to some pattern and/or a random arrangement.

It is understood that in some embodiments the continuous antenna layer 227 includes a single continuous antenna layer supported along a single supporting structure, such as the example cable 221. Alternatively, or in addition, the continuous antenna layer 227 may include a segmented arrangement in which the continuous antenna layer 227 includes distributed surface antenna segments, e.g., with each segment including one or more antenna modules 222, one or more interface modules 224 and optionally, one or more other configurable modules 226. In some embodiments, each surface antenna segment may include a respective WTG 225. Alternatively, or in addition, a WTG 225 may be operable over some group of multiple surface antenna segments. It is envisioned that the continuous antenna layer 227 may extend over relatively large distances, e.g., hundreds of yards, thousands of yards, or even miles.

Overall, FIG. 2C showcases a highly adaptable and integrated sensor module surface assembly designed to enhance network performance through its configurable components and dynamic operation.

FIG. 2D is a block diagram illustrating an example, non-limiting embodiment of a configurable surface system 230 functioning within the communication system 100 of FIG. 1 in accordance with various aspects described herein. The configurable surface system 230 includes at least one configurable surface module assembly 239, which includes a substrate 235 sized and shaped to support an array of configurable modules 236a, 236b, 236c, generally 236. For example, the substrate 235 can include an elongated structure sized and shaped to support the array of configurable modules 236, e.g., according to a linear array extending along a length of the substrate 235. In at least some embodiments, the substrate 235 also includes at least one signal path 237 coupled between the array of configurable modules 236. In at least some embodiments, the signal path 237 can connect to one or more other units, such as the wireless terminal generator 225 (FIG. 2C). In at least some embodiments, the array of configurable modules 236 can be dynamically adjusted to function as antennas, baseband units, or other network components. This configuration is central to the system's ability to adapt to changing communication requirements and/or network conditions. In at least some embodiments, the array of configurable modules 236 are integral to the surface assembly, offering the ability to dynamically adjust their function based on any combination of a communication requirement, a network requirement and/or condition, and environmental conditions. The array of configurable modules 236 provide the flexibility needed for efficient network management.

In at least some embodiments, the configurable surface module assembly is adapted for attachment to a supporting structure. According to the illustrative example, the supporting structure is a cable 231, which serves as a primary physical infrastructure, supporting a deployment of the configurable surface system 230 across diverse environments. For example, the cable 231 acts as a backbone for the configurable surface system 230, integrating all components. The cables can include overhead cables as may be supported by utility poles, supporting towers and/or other architectural structures, such as buildings. It is understood that in some embodiments, the cable 231 may be limited to a supporting structure, such as a passive or inert cable. Alternatively, or in addition, the cable 231 may support another function that can be linked to the configurable surface system 230 or otherwise separated and/or isolated from the configurable surface system 230. According to the illustrative example, the cable 231 can include first and second functional members 233a, 233b, generally 233, e.g., wires, cables and/or optical fibers, which may be accompanied by one or more messengers 234. The messengers 234 can provide essential structural support to the cable 231 and other components, e.g., the functional members 233, ensuring the stability and integrity of the assembly. This support can be crucial for maintaining the assembly's reliability in various deployment scenarios.

In at least some embodiments, the cable may include a cladding and/or an outer jacket 232, e.g., providing environmental protection for the functional members 233 and/or messengers 234. In some embodiments, the configurable surface module assembly 239 can be configured for attachment to the cable 231. For example, the substrate 235 may be configured as a sleeve and/or a portion of a sleeve, which can be sized and/or otherwise shaped to contain at least a portion of the cable 231 therein. In some embodiments, the substrate 235 may be rigid, e.g., a conduit, a pipe and/or some other rigid supporting frame that may include openings, e.g., a cage. Alternatively, or in addition, the substrate 235 may be flexible, bendable, pliable, e.g., as in a flexible tube, a fabric, a screen and/or a mesh. In this arrangement, the configurable modules 236 of the configurable surface module assembly 239 can be arranged in a substantially linear array, which can be sized to extend over a substantial length of the cable 231. For example, the length of the cable 231 may be measured in tens of feet, hundreds of feet, thousands of feet, and/or miles. Accordingly, the cable 231 may be configured with one or more configurable surface module assemblies that may be arranged in an interconnected configuration, e.g., in a series configuration extending along a substantial length of the cable.

It is understood that in at least some embodiments, a spacing between configurable modules 236 of the configurable surface module assemblies 239 may be uniform. Alternatively, or in addition, the spacing between configurable modules 236 of the same configurable surface module assembly 239 may be non-uniform. In at least some embodiments, spacing between configurable modules 236 of each module may be uniform, however, the uniform spacing may differ among an arrangement of multiple surface module assemblies 239. It is further understood that a size, arrangement and/or spacing of the configurable surface module assemblies 239 along the cable 231 and/or a size, arrangement and/or spacing between configurable modules 236 of the configurable surface module assemblies 239 may be determined and/or otherwise selected according to a performance requirement. The performance requirement may relate to one or more of power consumption, wireless service coverage, anticipated utility and/or congestion and the like.

In at least some embodiments, the configurable modules 236 of a single and/or arrangement of configurable surface module assemblies 239 can be arranged to provide a continuous antenna layer 227. Such an integrated layer of antennas can be designed to provide consistent and/or adaptable network coverage. This integrated layer ensures that the network can dynamically respond to varying coverage needs.

The interconnections between these components enable the surface assembly to dynamically manage network resources and provide efficient wireless communication services. The cable 231 integrates all components, providing a robust platform for deployment. The continuous antenna layer 227 and configurable modules 236a, 236b, 236c work together to optimize network performance, while the signal path 237 ensures seamless data exchange and coordination within the assembly. The structural support member or messenger 234 maintains the integrity of the assembly, allowing for reliable operation in various environments. Overall, FIG. 2D showcases a highly adaptable and integrated module surface assembly designed to enhance network performance through its configurable components and dynamic operation.

FIG. 2E is a block diagram illustrating an example, non-limiting embodiment of an interface module 240 functioning within the adaptive wireless access system 200 of FIG. 2A in accordance with various aspects described herein. FIG. 2E shows an interface module 240, which plays a role in facilitating an interconnection of configurable modules 209 (FIG. 2A), such as the configurable sensor modules 210 (FIG. 2B), to other devices and systems, such as the WTGs 205 and/or the macro cell terminal anchors 202 (FIG. 2A). In at least some embodiments, the interface module 240 is designed to operate passively, as shown, meaning the module does not require an external power source to function. Such passive operation is advantageous for reducing energy consumption and simplifying deployment.

According to the illustrative example, the passive interface module 243 is in communication with a channel-guiding structure 241. In at least some embodiments, the channel guiding structure 241 is configured to guide a multi-channel information signal including a first information signal and a second information channel. For example, the channel guiding structure 241 may include one or more electrical conductors, such as a wire, twisted pair, a conductive printed circuit board trace, a conductive semiconductor trace, and/or a waveguide, e.g., microstrip, twin line. By way of example, a waveguide may include a hollow waveguide, a filled or partially filled waveguide, a coaxial waveguide. In at least some embodiments, the channel-guiding structure 241 includes a dielectric waveguide, such as a light pipe and/or optical fiber cable. The multi-channel information signal can include one or more of an include an electrical signal, a radiofrequency (RF) signal, a millimeter wave signal, a terahertz signal, an infrared signal and/or an optical signal.

In at least some embodiments, the passive interface module 243 includes a channel-selective device 244 configured to selectively direct a first information channel toward a first destination, e.g., a local process module, such as the example configurable modules 209 and/or the configurable sensor modules 210, while facilitating a directing of a second information channel to proceed towards a second destination.

The channel-guiding structure 241 can be coupled to the interface module 243 and/or at least partially incorporated into the passive interface module 243, e.g., serving as conduits for optical signals. According to the illustrative example, the channel-guiding structure 241 includes a waveguide responsible for transmitting light-based data signals, which can be used for both communication and power transmission. The use of light waveguides allows for high-speed data transfer and minimal signal loss over long distances, making them suitable for incorporation into smart surfaces or cables.

The passive interface module 243 serves as an important component within the interface module 240. According to the illustrative embodiment, the channel-selective device 244 includes a reflective surface, e.g., a mirror, which plays a significant role in directing the light signals. The mirror can provide a wavelength dependent response, e.g., reflecting and/or redirect light waves to different paths according to different operational wavelengths, allowing the passive interface module 243 to manage the flow of optical signals efficiently. This capability is beneficial to facilitate routing signals to the appropriate destinations, such as local processing at the 1^{st} antenna 242a or other passive interface modules/antennas 242b.

In this regard, local processing at the 1^{st} antenna 242a can be facilitated by the passive interface module 243. This local processing capability allows for immediate data handling and decision-making at the point of signal reception, which can enhance the responsiveness and efficiency of the system. By processing data locally, the system can reduce latency and improve the overall performance of the network.

The output to other passive interface modules/antenna(s) 242b is another significant feature of the interface module 240. This output capability ensures that processed signals can be transmitted to subsequent modules or antennas, enabling a seamless flow of information across the network. This feature supports the scalability and adaptability of the system, allowing the system to accommodate various configurations and network topologies.

Overall, the passive interface module 243, featuring waveguides, and an integrated mirror, offers a robust solution for managing optical signals in a dynamic network environment. The module's capability to facilitate local processing and interconnect with other passive interface modules/antenna(s) 242b enhances the flexibility and efficiency of the network, making the module an important component in the deployment of smart, on-demand wireless-wireline converged infrastructures.

FIG. 2F is a block diagram illustrating an example, non-limiting embodiment of a power-deriving interface system 245 functioning within the adaptive wireless access system 200 of FIG. 2A in accordance with various aspects described herein. The power-deriving interface system 245 includes in interface module 248 in communication with a waveguide 246. The waveguide 246 can serve as a conduit for transmitting signals 247 within the system 245. In at least some embodiments, the signals 247 are electromagnetic signals, e.g., microwave signals, millimeter wave signals, terahertz signals and/or optical signals. In at least some embodiment, the interface module 248, enabling high-speed data transfer and minimal signal loss, which is essential for efficient communication and/or power transmission across a network.

In at least some embodiments, the interface module receives the signal 247 and directs a first signal portion 247′a toward a power conversion module 250. The power conversion module 250 can be configured to generate electrical power from the received first signal portion 247′a. For example, the power conversion module 250 may include a signal detector, such as a square-law converter, e.g., a semiconductor device or junction configured to produce an electrical current responsive to the received first signal portion 247′a. In at least some embodiments, the power conversion module 250 may include additional circuitry, e.g., a rectifier and/or a filter to condition the received power, e.g., producing a stable electrical current. In at least some embodiments, the power conversion module includes a photocell, e.g., a soar cell, photodetector, e.g., a photo diode, and the like. The electrical power, e.g., in the form of an electrical current and/or voltage, can be routed to one or more of a configurable module 251, e.g., via a wire, a lead and/or an electrical circuit 252.

According to the illustrative example, the interface module 248 includes a first redirector, e.g., a first reflector 249a, such as mirror that may be adapted to provide a first reflectivity. The first reflectivity value can be relatively high, e.g., at and/or approaching 100%, e.g., to redirect substantially the entire signal 247 to obtain a redirected signal 247′ in another direction relative to a direction of the signal 247 toward the configurable module 251. Alternatively, or in addition, the example interface module 248 can include a second redirector, e.g., a second reflector 249a, such as another mirror that may be adapted to provide a second reflectivity. The second reflectivity may be selected to reflect a predetermined fraction or percentage of the redirected signal 247′. In particular, the second reflector 249b is adapted to provide a second reflectivity that is less than 100%. In at least some embodiments, one or more of the first and second redirectors can include a mirror, a prism, a lens, a waveguide, a light pipe, an optical fiber and any combination thereof.

The percentage may be determined according to the second reflectivity, e.g., to control and/or otherwise limit a second portion of the redirected signal 247′b, while diverting a remainder, e.g., the first portion of the redirected signal 247′a toward the power conversion module 250. For example, the second reflector 249b may be configured to allow the limited portion of the redirected signal 247′b to proceed toward the configurable module 251, e.g., being transmitted through the second reflector, rather than being reflected.

The interconnections between these components enable the interface module 248 to effectively manage received signals and data processing tasks. The waveguides 246 transmit signals to the local processing unit configurable module 251, where data is processed. The passive interface module 248 and the first and second reflectors 249a, 249b work together to ensure that light signals are accurately reflected and routed, maintaining the integrity and efficiency of data transmission within the network, while also ensuring that the interface module 248 produces electrical power as may be at least sufficient to power at least some functions of the configurable module 251.

Overall, FIG. 2F illustrates a sophisticated interface module designed to enhance network performance through its efficient handling of optical signals and data processing capabilities, making it a crucial component in the deployment of smart, on-demand wireless-wireline converged infrastructures.

FIG. 2G is a block diagram illustrating an example, non-limiting embodiment of a distributed, configurable surface assembly architecture 255a functioning within the communication system 100 of FIG. 1 in accordance with various aspects described herein. The distributed, configurable surface assembly architecture 255a includes an elongated module foundation 257a supporting a distributed group of configurable electronic modules 258a over a length of the elongated module foundation 257a. In at least some embodiments, the configurable surface assembly architecture 255a includes a wireless terminal generator 256 in communication with the group of configurable electronic modules 258a. The wireless terminal generator 256 can be configured to control a configuration of one or more of the configurable electronic modules of the distributed group of configurable electronic modules 258a.

In at least some embodiments, the distributed, configurable surface assembly architecture 255a is configurable to perform one or more communication functions. It is envisioned that, without limitation, the communication functions can include mobile cellular communication functions including one or more of user plane functions, control plane functions, RAN functions and/or other supporting functions as may be beneficial in providing functionality at a network edge including at least some configurable electronic modules of the distributed group of configurable electronic modules 258a.

It is understood that at least a first subgroup, including one or more configurable electronic modules of the distributed group of configurable electronic modules 258a may be configured, e.g., by the wireless terminal generator 256a, to support communication functions related to wireless delivery and/or support of a first communication service, e.g., a mobile service, to mobile user equipment 259a. In at least some embodiments, the wireless terminal generator 256a, may adjust, e.g., reconfigure, at least some configurable electronic modules of the first subgroup to support communication functions related to wireless delivery and/or support of a mobile service to mobile user equipment 259a. It is understood that, in at least some embodiments, such reconfigurations may be based on a location of the mobile user equipment 259a, which may be moving, with respect to the elongated module foundation 257a. For example, at least some of the configurable electronic modules of the first subgroup are selected and/or otherwise configured based on a proximity to a location of the mobile user equipment 259a and/or an anticipated future location of the mobile user equipment 259a, e.g., based on an estimated speed and/or direction of movement of the mobile user equipment 259a.

Alternatively, or in addition, a second subgroup, including one or more configurable electronic modules of the distributed group of configurable electronic modules 258a may be configured, e.g., by the wireless terminal generator 256a, to support communication functions related to wireless delivery and/or support of a first and/or second communication service to premises equipment 260a. In at least some embodiments, the wireless terminal generator 256a, may adjust, e.g., reconfigure, at least some configurable electronic modules of the first subgroup to support communication functions related to delivery and/or support of the premises equipment 260a. It is understood that such reconfigurations may be based on a location of the premises equipment 260a and/or a communication requirement as may related to the premises equipment 260a. For example, at least some of the configurable electronic modules of the second subgroup are selected and/or otherwise configured based on a proximity to a location of the premises equipment 260a. It is understood further that other subgroups of the group of configurable electronic modules 258a may be configured to support other premises (not shown), e.g., based on relative locations of the premises with respect to the elongated module foundation 257a. In at least some embodiments, the service may related to a, so called, “last mile” connectivity of a network service including mobile service and/or premises services, such as internet service, cable service, voice communication service, and so on.

In at least some embodiments, one or more other subgroups, including one or more configurable electronic modules of the distributed group of configurable electronic modules 258a may be configured, e.g., by the wireless terminal generator 256a, to support other communication functions related to wireless delivery and/or support of the example first and/or second communication services. For example, the other subgroups may support user plane functions, control plane functions and/or core functions of a communication service, such as a mobile cellular communication service, including communications with one or more other networks 261a.

The interconnections between these components enable the distributed, configurable surface assembly architecture to dynamically manage network resources and provide efficient wireless communication services. The wireless terminal generator is in communication with the group of configurable electronic modules 258a to manage their configuration and/or operation, ensuring enhanced and, in at least some embodiments, optimal performance, e.g., based on user demand, network conditions, user equipment capabilities and/or environmental conditions. The elongated module foundation 257a can include communication circuits, conductive leads, cables, waveguides, optical fibers and/or transmission lines configured to integrate the group of configurable electronic modules 258a and the wireless terminal generator 256a, providing a robust platform for deployment and facilitating seamless data flow between the user equipment 259a and other networks 261a.

Overall, FIG. 2G illustrates a sophisticated and adaptable surface assembly architecture designed to enhance network performance through its configurable components and dynamic operation, ensuring efficient and reliable connectivity for users.

FIG. 2H is a block diagram illustrating an example, non-limiting embodiment of another, alternative distributed, configurable surface assembly architecture 255b functioning within the communication system 100 of FIG. 1 in accordance with various aspects described herein. The other alternative, configurable surface assembly architecture 255b includes first and second elongated module foundations 257b, 257b′ respectively supporting distributed groups of configurable electronic modules 258b, 258b′ over respective lengths of the elongated module foundations 257b, 257b′. In at least some embodiments, the alternative configurable surface assembly architecture 255b includes a first wireless terminal generator 256b in communication with a first distributed group of configurable electronic modules 258b and a second wireless terminal generator 262a in communication with the second distributed group of configurable electronic modules 258b'. The first and second wireless terminal generators 256b, 262a can be configured to control respective configurations of one or more of the configurable electronic modules of the first and second distributed groups of configurable electronic modules 258b, 258b'. According to the illustrative example, the second wireless terminal generator 262a can include additional functionality, such as any of the example user plane functions, control plane functions, core network functions, and the like.

In at least some embodiments, the alternative distributed, configurable surface assembly architecture 255b is configurable to perform one or more communication functions. It is envisioned that, without limitation, the communication functions can include mobile cellular communication functions including one or more of user plane functions, control plane functions, RAN functions and/or other supporting functions as may be beneficial in providing functionality at a network edge including at least some configurable electronic modules of the first and second distributed groups of configurable electronic modules 258b, 258b′.

It is understood that at least a first subgroup, including one or more configurable electronic modules of either or both of the first and second distributed groups of configurable electronic modules 258b, 258b′ may be configured, e.g., by the first and second wireless terminal generators 256b, 262a, to support communication functions related to wireless delivery and/or support of a first communication service, e.g., a mobile service, to mobile user equipment 259b. In at least some embodiments, the first and/or second wireless terminal generators 256b, 256b′, may adjust, e.g., reconfigure, at least some configurable electronic modules of their respective first subgroups to support communication functions related to wireless delivery and/or support of a mobile service to mobile user equipment 259b.

Alternatively, or in addition, a second subgroup, including one or more configurable electronic modules of either or both of the first and second distributed groups of configurable electronic modules 258b, 258b′ may be configured, e.g., by the first and second wireless terminal generators 256b, 262a, to support communication functions related to wireless delivery and/or support of a first and/or second communication service to premises equipment 260b. In at least some embodiments, the first and/or second wireless terminal generators 256b, 256b′, may adjust, e.g., reconfigure, at least some configurable electronic modules of their respective first subgroups to support communication functions related to delivery and/or support of the premises equipment 260b.

In at least some embodiments, one or more other respective subgroups, including one or more configurable electronic modules of the first and/or second distributed groups of configurable electronic modules 258b, 258b′ may be configured, e.g., by the respective wireless terminal generator 256b, 262a, to support other communication functions related to wireless delivery and/or support of the example first and/or second communication services. For example, the other subgroups may support user plane functions, control plane functions and/or core functions of a communication service, such as a mobile cellular communication service, including communications with one or more other networks 261b.

The interconnections between these components enable the distributed, configurable surface assembly architecture to dynamically manage network resources and provide efficient wireless communication services. The wireless terminal generators 256b, 262a are in communication with their respective first and second groups of configurable electronic modules 258b, 258b′ to manage their configuration and/or operation, ensuring enhanced and, in at least some embodiments, optimal performance, e.g., based on user demand, network conditions, user equipment capabilities and/or environmental conditions. In at least some embodiments, any of the example communication functions and/or services may be delivered and/or otherwise supported jointly by at least some configurable electronic modules of the first and second groups of configurable electronic modules 258b, 258b and/or jointly by the first and second wireless terminal generators 256b, 262a.

Overall, FIG. 2H illustrates a sophisticated and adaptable surface assembly architecture designed to enhance network performance through its configurable components and dynamic operation, ensuring efficient and reliable connectivity for users.

FIG. 2I is a block diagram illustrating an example, non-limiting embodiment of a mobile, configurable surface assembly architecture 255c functioning within the communication system 100 of FIG. 1 in accordance with various aspects described herein. The mobile, configurable surface assembly architecture 255c includes an elongated module foundation 257c supporting a group of configurable electronic modules 258c over a length of the elongated module foundation 257c. In at least some embodiments, the configurable surface assembly architecture 255c includes a mobile wireless terminal generator 256c in communication with the group of configurable electronic modules 258c. The mobile wireless terminal generator 256c can be configured to control a configuration of one or more of the configurable electronic modules of the group of configurable electronic modules 258c.

According to the example embodiment, the elongated module foundation 257c, the group of configurable electronic modules 258c, and the mobile wireless terminal generator 256c are attached to a mobile platform 263a. The mobile platform 263a can include, without limitation, a vehicle, such as an automobile, a truck, a train and/or a boat. Alternatively, or in addition, the mobile platform 263a can include an airborne platform, such as an airplane, a helicopter, a drone, a lighter than air vehicle, and so on. In at least some embodiments, the mobile platform 263a can include a spaceborne platform, such as a satellite. It is understood that in at least some embodiments, the elongated module foundation 257c is adapted for attachment to the mobile platform. The elongated module foundation 257c can include a mechanical fastening means, such as a screw, a bolt, a rivet, a staple, a belt, a clamp, a hook-and-loop fastener, and the like. Alternatively, or in addition, the elongated module foundation 257c can include a chemical fastening means, such as a glue, a resin, and/or an epoxy. In at least some embodiments, the fastening means can include a weld.

In at least some embodiments, the distributed, configurable surface assembly architecture 255c is configurable to perform one or more communication functions. It is envisioned that, without limitation, the communication functions can include mobile cellular communication functions including one or more of user plane functions, control plane functions, RAN functions, core functions and/or other supporting functions as may be beneficial in providing functionality at a network edge including at least some configurable electronic modules of the distributed group of configurable electronic modules 258c.

It is understood that at least a first subgroup, including one or more configurable electronic modules of the group of configurable electronic modules 258c may be configured, e.g., by the mobile wireless terminal generator 256c, to support communication functions related to wireless delivery and/or support of a first communication service, e.g., a mobile service, to mobile user equipment 259c. In at least some embodiments, the mobile wireless terminal generator 256c, may adjust, e.g., reconfigure, at least some configurable electronic modules of the first subgroup to support communication functions related to wireless delivery and/or support of a mobile service to mobile user equipment 259c. It is understood that, in at least some embodiments, such reconfigurations may be based on a location of the mobile user equipment 259c, which may be moving, with respect to the elongated module foundation 257c. This includes motion of the mobile user equipment 259c with stationary mobile user platform 263a, motion of the mobile platform 263a with stationary mobile user equipment 259c, and/or relative motion between both. For example, at least some of the configurable electronic modules of the first subgroup are selected and/or otherwise configured based on a proximity to a location of the mobile user equipment 256c and/or an anticipated future location of the mobile user equipment 256c and/or the mobile platform 263a, e.g., based on an estimated speed and/or direction of movement of the mobile user equipment 259a and/or the mobile platform 263a.

Alternatively, or in addition, a second subgroup, including one or more configurable electronic modules of the group of configurable electronic modules 258c may be configured, e.g., by the mobile wireless terminal generator 256a, to support communication functions related to wireless delivery and/or support of a first and/or second communication service to premises equipment 260c. In at least some embodiments, the mobile wireless terminal generator 256c, may adjust, e.g., reconfigure, at least some configurable electronic modules of the first subgroup to support communication functions related to delivery and/or support of the premises equipment 260c. It is understood that such reconfigurations may be based on a location of the premises equipment 260c, location of the mobile platform 263a and/or a combination of the locations of both. Alternatively, or in addition, such reconfigurations may be based on communication requirement as may related to the premises equipment 260c. For example, at least some of the configurable electronic modules of the second subgroup are selected and/or otherwise configured based on a proximity of the mobile platform 263a to a location of the premises equipment 260c. It is understood further that other subgroups of the group of configurable electronic modules 258c may be configured to support other premises (not shown), e.g., based on relative locations of the premises with respect to the mobile platform 263a. In at least some embodiments, the service may be related to a, so called, “last mile” connectivity of a network service including mobile service and/or premises services, such as internet service, cable service, voice communication service, and so on.

In at least some embodiments, one or more other subgroups, including one or more configurable electronic modules of the group of configurable electronic modules 258c may be configured, e.g., by the mobile wireless terminal generator 256c, to support other communication functions related to wireless delivery and/or support of the example first and/or second communication services. For example, the other subgroups may support user plane functions, control plane functions and/or core functions of a communication service, such as a mobile cellular communication service, including communications with one or more other networks 261c.

The interconnections between these components enable the distributed, configurable surface assembly architecture to dynamically manage network resources and provide efficient wireless communication services. The wireless terminal generator is in communication with the group of configurable electronic modules 258c to manage their configuration and/or operation, ensuring enhanced and, in at least some embodiments, optimal performance, e.g., based on user demand, network conditions, user equipment capabilities and/or environmental conditions. The elongated module foundation 257c can include communication circuits, conductive leads, cables, waveguides, optical fibers and/or transmission lines configured to integrate the group of configurable electronic modules 258c and the mobile wireless terminal generator 256c, providing a robust platform for deployment and facilitating seamless data flow between the user equipment 259c, premises equipment 260c, and/or other networks 261a.

Overall, FIG. 2I illustrates a sophisticated and adaptable surface assembly architecture designed to enhance network performance through its configurable components and dynamic operation, ensuring efficient and reliable connectivity for users.

FIG. 2J is a block diagram illustrating an example, non-limiting embodiment of a distributed, configurable surface assembly architecture 255d functioning within the communication system 100 of FIG. 1 in accordance with various aspects described herein. The distributed, configurable surface assembly architecture 255d includes an elongated module foundation 257d supporting a group of configurable electronic modules 258d over a length of the elongated module foundation 257d. In at least some embodiments, the configurable surface assembly architecture 255d includes a wireless terminal generator 256d in communication with the group of configurable electronic modules 258d. The wireless terminal generator 256d can be configured to control a configuration of one or more of the configurable electronic modules of the group of configurable electronic modules 258d.

According to the example embodiment, the elongated module foundation 257d, the group of configurable electronic modules 258d, and the wireless terminal generator 256d are attached to a stationary structure 263b, such as a building, e.g., customer premises. It is understood that in at least some embodiments, the elongated module foundation 257d is adapted for attachment to the stationary structure 263b. The elongated module foundation 257d can include a mechanical fastening means, such as a screw, a bolt, a rivet, a staple, a belt, a clamp, a hook-and-loop fastener, and the like. Alternatively, or in addition, the elongated module foundation 257d can include a chemical fastening means, such as a glue, a resin, and/or an epoxy. In at least some embodiments, the fastening means can include a weld.

In at least some embodiments, the distributed, configurable surface assembly architecture 255d is configurable to perform one or more communication functions. It is envisioned that, without limitation, the communication functions can include mobile cellular communication functions including one or more of user plane functions, control plane functions, RAN functions, core functions and/or other supporting functions as may be beneficial in providing functionality at a network edge including at least some configurable electronic modules of the distributed group of configurable electronic modules 258d.

It is understood that at least a first subgroup, including one or more configurable electronic modules of the group of configurable electronic modules 258d may be configured, e.g., by the mobile wireless terminal generator 256d, to support communication functions related to wireless delivery and/or support of a first communication service, e.g., a mobile service, to mobile user equipment 259d. In at least some embodiments, the mobile wireless terminal generator 256d, may adjust, e.g., reconfigure, at least some configurable electronic modules of the first subgroup to support communication functions related to wireless delivery and/or support of a mobile service to mobile user equipment 259d. It is understood that, in at least some embodiments, such reconfigurations may be based on a location of the mobile user equipment 259d, which may be moving, with respect to the elongated module foundation 257d. This includes motion of the mobile user equipment 259d. For example, at least some of the configurable electronic modules of the first subgroup are selected and/or otherwise configured based on a proximity to a location of the mobile user equipment 256cd and/or an anticipated future location of the mobile user equipment 259d, e.g., based on an estimated speed and/or direction of movement of the mobile user equipment 259d.

Alternatively, or in addition, a second subgroup, including one or more configurable electronic modules of the group of configurable electronic modules 258d may be configured, e.g., by the wireless terminal generator 256d, to support communication functions related to wireless delivery and/or support of a first and/or second communication service to premises equipment 260d. In at least some embodiments, the wireless terminal generator 256d, may adjust, e.g., reconfigure, at least some configurable electronic modules of the first subgroup to support communication functions related to delivery and/or support of the premises equipment 260d. It is understood that such reconfigurations may be based on a location of the premises equipment 260d, location of the structure 263b and/or a combination of the locations of both. Alternatively, or in addition, such reconfigurations may be based on communication requirement as may related to the premises equipment 260d. For example, at least some of the configurable electronic modules of the second subgroup are selected and/or otherwise configured based on a proximity of the structure 263b to a location of the premises equipment 260d. It is understood further that other subgroups of the group of configurable electronic modules 258d may be configured to support other premises (not shown), e.g., based on relative locations of the premises with respect to the structure 263b. In at least some embodiments, the service may be related to a, so called, “last mile” connectivity of a network service including mobile service and/or premises services, such as internet service, cable service, voice communication service, and so on.

In at least some embodiments, one or more other subgroups, including one or more configurable electronic modules of the group of configurable electronic modules 258d may be configured, e.g., by the wireless terminal generator 256d, to support other communication functions related to wireless delivery and/or support of the example first and/or second communication services. For example, the other subgroups may support user plane functions, control plane functions and/or core functions of a communication service, such as a mobile cellular communication service, including communications with one or more other networks 261d.

The interconnections between these components enable the distributed, configurable surface assembly architecture to dynamically manage network resources and provide efficient wireless communication services. The wireless terminal generator is in communication with the group of configurable electronic modules 258d to manage their configuration and/or operation, ensuring enhanced and, in at least some embodiments, optimal performance, e.g., based on user demand, network conditions, user equipment capabilities and/or environmental conditions. The elongated module foundation 257d can include communication circuits, conductive leads, cables, waveguides, optical fibers and/or transmission lines configured to integrate the group of configurable electronic modules 258d and the wireless terminal generator 256d, providing a robust platform for deployment and facilitating seamless data flow between the user equipment 259d, premises equipment 260d, and/or other networks 261d.

Overall, FIG. 2J illustrates a sophisticated and adaptable surface assembly architecture designed to enhance network performance through its configurable components and dynamic operation, ensuring efficient and reliable connectivity for users.

FIG. 2K is a block diagram illustrating an example, non-limiting embodiment of a steerable distributed antenna system 265a, 265b functioning within the communication system 100 of FIG. 1 in accordance with various aspects described herein. In particular, FIG. 2K highlights the components and their roles in facilitating dynamic and efficient network coverage provided by the steerable distributed antenna system 265a, 265b. The steerable distributed antenna system 265a includes an elongated module support structure, e.g., a cable 266 that includes a group of steerable antenna modules 268a, 268b, 268c, 268d, 268e, generally 268. The steerable antenna modules 268 are coupled to an antenna system bus 267, which is in further communication with a wireless terminal generator 256a. In at least some embodiments, the wireless terminal generator 256a is configured to control a steering of one or more of the steerable antenna modules 268.

The interconnections between these components enable the steerable distributed antenna system to dynamically manage network resources and provide efficient wireless communication services. The wireless terminal generator 256e interfaces with the steerable antenna modules 268a, 268b, 268c, 268d, 268e to manage their configuration and operation, ensuring optimal performance based on user demand and environmental conditions. The cable 266 integrates all components, providing a robust platform for deployment, while the antenna system bus 267 ensures seamless data exchange and coordination within the system.

In at least some embodiments, one or more of the steerable antenna modules 268 are electrically steerable, without necessarily including any provisions for mechanical steering. For example, electrical steering may be performed by varying one or more of an amplitude or a phase of an antenna stimulation signal, such that the varied signal parameter alone or in combination with an arrangement, e.g., a spacing, of the steerable antenna modules 268 controls a directivity of the antenna, e.g., varying an angle with respect to the example linear arrangement of steerable antenna modules.

Alternatively, or in addition, one or more of the steerable antenna modules 268 is mechanically steerable. For example, at least some of the steerable antenna modules 268 are coupled to the antenna system bus 267 and/or the elongated module support structure, e.g., the cable 266 via a mechanical linkage 269. The mechanical linkage 269 may include one or more of rods and/or gears arranged to reposition one or more of the steerable antenna modules 268. In at least some embodiments, the antenna system bus 267 can be configured to operate as a communication backbone within the antenna system, interconnecting the various modules and enabling efficient data transfer and coordination.

According to the illustrative example, the mechanical linkages 269 are configured such that at least some and in some instances all of the steerable antenna modules 268 are pointing in the same direction. In this instance, the first antenna module 268a is pointing in a first direction Da, the first antenna module 268b is pointing in a first direction Db, the first antenna module 268c is pointing in a third direction Dc, the fourth antenna module 268d is pointing in a fourth direction Dd, a fifth antenna module 268e is pointing in a first direction De. According to a first configuration, e.g., referred to as a default mode, Da=Db=Dc=Dd=De.

The wireless terminal generator 256e can be configured, at least in part, to function as an intelligent antenna controller. Namely, the wireless terminal generator 256e cam function as a central control unit, managing the configuration and operation of the steerable antenna modules 268, e.g., by prescribing and/or assigning signal properties for mechanical steering and/or operation of the mechanical linkages 269. The wireless terminal generator 256e can play a crucial role in ensuring that the antenna system adapts to changing network conditions and user demands.

The steerable antenna modules 268 are designed to provide flexible and targeted wireless coverage. Each module 268 can adjust its orientation and configuration, e.g., under control and/or direction of the wireless terminal generator 256e, to optimize signal reception and transmission based on environmental conditions and user demand.

The steerable distributed antenna system 265b represents an altered configuration of the steerable antenna modules 268, in which one or more of the steerable antenna modules 268 are oriented in different directions from other ones of the steerable antenna modules 268. Alternatively, or in addition, the altered configuration may include some and possibly all of the steerable antenna modules 268 oriented in a common direction that differs from a default mode orientation.

Overall, FIG. 2K illustrates a sophisticated and adaptable steerable distributed antenna system designed to enhance network performance through its configurable components and dynamic operation, ensuring efficient and reliable connectivity for users.

FIG. 2L is a block diagram illustrating an example, non-limiting embodiment of a distributed, adaptive surface antenna system 270 functioning within the communication system 100 of FIG. 1 in accordance with various aspects described herein. FIG. 2L provides a detailed view of the example system 270, highlighting its components and their roles in facilitating efficient and dynamic network coverage. According to the illustrative embodiment, the distributed, adaptive surface antenna system 270 includes first and second supporting tower 272a, 272b, generally 272. The supporting towers 272 represent physical structures that support one or more overhead cables 271, such as power cables, telecommunication cables and combinations thereof. It is understood that overhead cables 271 represent an example of an elongated module supporting structure suitable for supporting and/or contributing to support of an example arrangement of configurable electronic modules 274, ensuring stability and proper alignment for optimal signal transmission and reception.

According to the illustrative example, the arrangement of configurable electronic modules 274 provides an adaptive surface antenna system, integrating various components and supporting their deployment across different environments. It acts as a platform for the antenna system, enabling efficient signal propagation. In at least some embodiments, the arrangement of configurable electronic modules 274 provides an adaptive surface millimeter wave antenna system, adapted for millimeter wave beamforming 273a. It is understood that beamforming technology can be used to direct millimeter wave signals to/from user equipment, optimizing signal strength and coverage based on user location and demand. Namely, millimeter wave signal propagation is highly localized, providing reliable coverage only within a limited physical distance, dₘₐₓ, from mobile user equipment 259e. To the extent that a size, e.g., a length of the arrangement of configurable electronic modules 274 exceeds dₘₐₓ, e.g., possibly by tens, hundreds or greater, it is understood that the beamforming may be confined to a limited group of configurable electronic modules 274a.

The arrangement of configurable electronic modules 274 in the example distributed, adaptive surface antenna system 270 can be designed to dynamically adjust its configuration to provide targeted and efficient wireless coverage to the mobile user equipment 259e. In particular, the distributed, adaptive surface antenna systems of the configurable electronic modules 274 leverages the supporting cables 271.

The interconnections between these components enable the arrangement of configurable electronic modules 274 in the adaptive surface antenna system 270 to dynamically manage network resources and provide efficient wireless communication services to the mobile user equipment 259e. The supporting towers 272a, 272b ensure the stability of the overhead cable 271. The millimeter wave via beamforming 273a enhances signal strength and coverage, ensuring optimal performance based on user demand and environmental conditions.

Overall, FIG. 2L illustrates a sophisticated and adaptable adaptive surface antenna system designed to enhance network performance through its configurable components and dynamic operation, ensuring efficient and reliable connectivity for users.

FIG. 2M is a block diagram illustrating an example, non-limiting embodiment of a multi-feed distributed antenna system 275 functioning within the communication system 100 of FIG. 1 in accordance with various aspects described herein by highlighting its components and their roles in facilitating efficient and dynamic network coverage. In at least some embodiments, the multi-feed distributed antenna system 275 includes a first configurable system generator 277a in communication with one portion of an adaptive surface antenna system 276 and a second configurable system generator 277b in communication with another portion of the adaptive surface antenna system 276. The configurable system generators 277a, 277b, generally 277, can act as control units, e.g., managing the activation and configuration of configurable modules of the adaptive surface antenna system 276. Alone, and/or in combination, the configurable system generators can play a crucial role in ensuring dynamic network coverage and resource allocation.

By way of example, the multi-feed distributed antenna system 275 operates in cooperation with a primary macro cell terminal 272c that can be configured to serve as a central communication hub, e.g., facilitating delivery of one or more mobile services to mobile user equipment 269f. In at least some embodiments, the multi-feed distributed antenna system 275 includes at least one secondary macro cell 272d. Services can include, without limitation, voice service, e.g., VoIP, data service, messaging service, streaming data service, emergency service and so on. In at least some embodiments, one or more of the macro cell terminals 272c, 272d, generally 272, are responsible for managing data flow and ensuring seamless connectivity. The mobile user equipment 269f can include, without limitation, mobile devices or terminals that connect to the network, receiving data and services facilitated by the multi-feed distributed antenna system, such as mobile phones, wearable devices, tablet devices, computers, smart home devices, automation equipment, smart vehicles, e.g., self-driving cars, drones, automation devices, such as robots and so on.

In at least some embodiments, the secondary macro cell terminal 272d acts as an additional communication hub, supporting the primary macro cell terminal 272c in managing data flow and connectivity. In at least some embodiments, the multi-feed distributed antenna system includes at least one user plane function (UPF) 279, e.g., including functions responsible for handling user data traffic, as may be beneficial in ensuring efficient data routing and processing within the network. It is understood that one or more of the primary macro cell terminal 272c, the secondary macro cell terminal 272d, and the UPF 279 may be in communication with one or more other networks 261e. In general, the other networks 261e represent external networks that the system can connect to, enabling broader communication and data exchange beyond the immediate network environment. Examples of other networks 261e include, without limitation, the Internet and/or a private network, e.g., an enterprise network.

According to the illustrative example embodiment, the multi-feed distributed antenna system 275 is designed to provide flexible and efficient wireless coverage by utilizing multiple feeds to enhance signal reception and transmission. For example, the adaptive surface antenna system 276 is operable to dynamically adjust its configuration and provide targeted wireless coverage. For example, the adaptive surface antenna system 276 is configured to implement a beamforming function, e.g., as may be applied to a localized service, such as millimeter wave beamforming to produce a relatively narrow or focused millimeter wave beam 273b that can be directed and/or otherwise redirected according to environmental conditions, such as a location of the mobile user equipment 269f. Beamforming technology can be used to direct millimeter wave signals towards the mobile user equipment 269f, e.g., to optimize signal strength and coverage based on user location and demand.

For example, the first wireless terminal generator 277a is configured to inject a first signal S₁ at the first location, whereas the second wireless terminal generator 277b is configured to inject a second signal S₂ at the second location. The two signals, S₁, S₂ combine in such a manner so as to affect a directivity of the resulting millimeter wave beam 273b, e.g., focusing and/or steering it in a predetermined manner as can be managed according to one or more of the signal properties of the first and second signals S₁, S₂ and/or the first and second locations as may affect signal properties, such as amplitude attenuation, delay, and the like.

The interconnections between the first and second wireless terminal generators 277a, 277b, generally 277, enable the multi-feed distributed antenna system 275 to dynamically manage network resources and provide efficient wireless communication services. The wireless terminal generators 277a, 277b, in turn, interface with the macro cell terminals 272c, 272d and the adaptive surface antenna system 276 to manage their configuration and operation.

Overall, FIG. 2M illustrates a sophisticated and adaptable multi-feed distributed antenna system designed to enhance network performance through its configurable components and dynamic operation, ensuring efficient and reliable connectivity for users.

FIG. 2N depicts an illustrative embodiment of a distributed surface assembly configuration process 280 in accordance with various aspects described herein. This figure outlines a series of steps or stages involved in configuring the distributed surface assembly to support, enhance and/or otherwise optimize network performance and resource allocation. The example process 280 is designed to dynamically adjust the configuration of the surface assembly based on network requirements and environmental conditions. According to an initial configuration, a communication requirement is determined at 281. This step involves setting up the initial parameters and configurations for the distributed surface assembly, which can be used as a baseline settings for the system's operation. The communication requirement can include, without limitation, a user demand for a mobile service as may be determined according to a quality of service (QoS), a type of service, e.g., voice, data, streaming data, a bandwidth, an operational frequency band, a mobile communication device type and/or capability, and so on.

According to the example process 280, a first location along a length of an extended, configurable processing system is determined, at 282, according to communication requirement. For example, network conditions can be monitored and/or otherwise informed from another monitoring system, e.g., to determine user demand, including location of a mobile user terminal, and to make real-time adjustments to the configuration of the surface assembly. Such timely reconfigurations can ensure that the network can adapt to changing conditions and maintain performance within a predetermined range, e.g., according to service level agreements (SLAs) and/or quality of service (QoS) parameters.

A first configurable module subgroup of the configurable processing system is identified at 283 according to the first location. This step focuses on allocating network resources efficiently across the distributed surface assembly. For example, the location may correspond to providing wireless service to a proximal location of the mobile user terminal. Alternatively, or in addition, the location may correspond to interference, whereby distributing processing to the first location avoids and/or otherwise mitigates effects of the interference. In at least some embodiments, allocating configurable resources based on the first location can involve prioritizing certain functions and/or areas based on current and/or anticipated network demands and service requirements.

According to the illustrative process 280, the configurable module subgroup can be configured, at 284, according to communication requirement. This step can involve adjusting and/or fine-tuning the extended configurable processing system to enhance overall network performance. By way of nonlimiting example, this fine-tuning can include adjusting and/or optimizing one or more of wireless signal strength, region of coverage, and/or data throughput to ensure reliable and efficient service delivery.

The interconnections between these example process steps enable the distributed surface assembly to dynamically manage network resources and provide efficient wireless communication services. The process 280 is designed to be flexible and responsive, allowing the system to adapt to varying network conditions and user demands. Overall, the example process 280 represents a sophisticated configuration process that enhances network performance through dynamic adjustments and resource optimization.

FIG. 2O depicts an illustrative embodiment of a distributed surface assembly configuration process 290 in accordance with various aspects described herein. The example process 290 is designed to ensure optimal network performance by adjusting the configuration of the surface assembly in response to the movement of mobile devices. According to an initial configuration, a first location of mobile device along a length of extended, configurable processing system is determined at 291. For example, it sets a starting point for the example configuration process 290.

According to the example process 290, movement of the mobile device is detected, e.g., according to changes in its location from a first location to a second location along the configurable processing system. This real-time tracking is crucial for adapting the network configuration to the device's new position.

Upon detecting movement, the example process 290 dynamically adjusts the configuration of the surface assembly to accommodate the mobile device's new location. For example, the adjusting of the configuration can involve reallocating resources and/or reconfiguring modules to maintain optimal coverage and connectivity. This may include activating one group of configurable modules and/or deactivating another group of configurable modules, as may be used to maintain proximity of the active modules of the surface assembly to a current and/or anticipated location of the mobile device. It is envisioned that in at least some embodiments, the configurable modules may include sensor modules, e.g., antenna modules, that may be activated and/or otherwise configured to support wireless communications with the mobile device.

According to the example process 290, a second configurable module subgroup is configured, at 294, according to movement of the mobile device. For example, the second configurable subgroup can be configured to ensure that the network continues to deliver high-quality service by maintaining performance parameters such as signal strength, coverage, and data throughput, even as the mobile device moves.

The interconnections between these steps enable the distributed surface assembly to effectively manage network resources and provide seamless wireless communication services. The process is designed to be adaptive and responsive, allowing the system to quickly adjust to changes in user location and network conditions. Overall, FIG. 2O illustrates a dynamic configuration process that enhances network performance by continuously adapting to user movement and environmental changes.

While for purposes of simplicity of explanation, the respective processes are shown and described as a series of blocks in FIGS. 2N and 2O, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

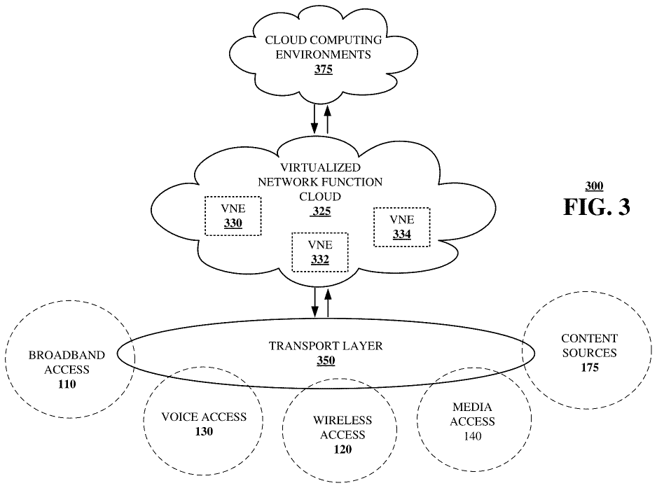

Referring now to FIG. 3, a block diagram is shown illustrating an example, non-limiting embodiment of a virtualized communication network 300 in accordance with various aspects described herein. In particular a virtualized communication network is presented that can be used to implement some or all of the subsystems and functions of system 100, the subsystems and functions of system 200, 210, 220, 230, 240, 245, 265, 270, 275 system architectures 255a, 255b, 255c, 255d, and processes 280, 290 presented in FIGS. 1, 2A, 2B, 2C, 2D, 2E, 2F, 2G, 2H, 2I, 2J, 2K, 2L, 2M, 2O and 3. For example, virtualized communication network 300 can facilitate in whole or in part utilization of an elongated structure supporting a group of configurable electronic modules that are dynamically configurable by a module configuration generator to support dynamic network coverage and resource allocation to meet mobile service requirements, thereby optimizing network performance in response to user demand and environmental conditions.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements-which are typically integrated to perform a single function, the virtualized communication network employs virtual network elements (VNEs) 330, 332, 334, etc., that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc., to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers-each of which adds a portion of the capability, and which creates an elastic function with higher availability overall than its former monolithic version. These virtual network elements 330, 332, 334, etc., can be instantiated and managed using an orchestration approach similar to those used in cloud compute services.

The cloud computing environments 375 can interface with the virtualized network function cloud 325 via APIs that expose functional capabilities of the VNEs 330, 332, 334, etc., to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

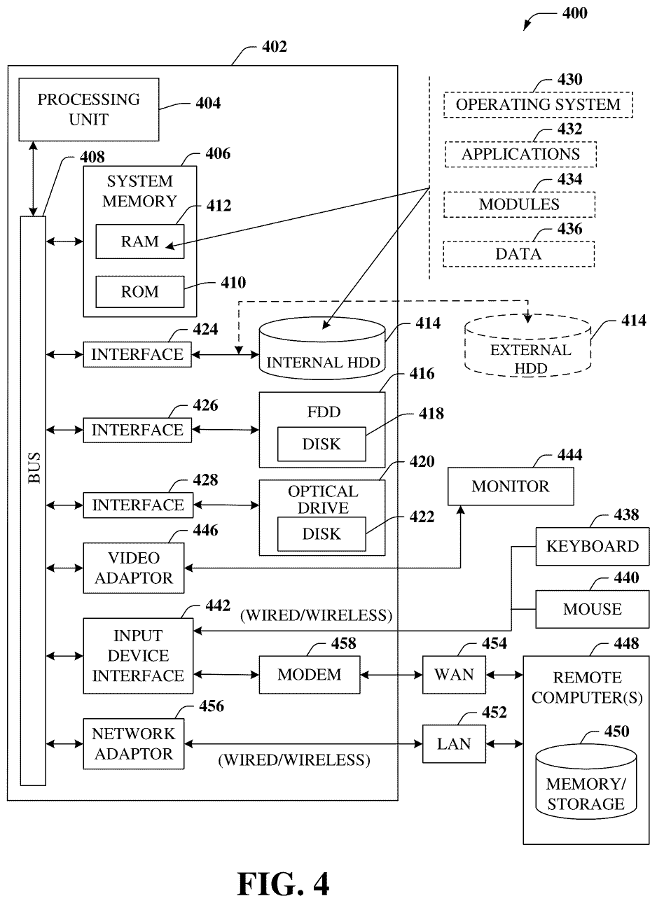

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part utilization of an elongated structure supporting a group of configurable electronic modules that are dynamically configurable by a module configuration generator to support dynamic network coverage and resource allocation to meet mobile service requirements, thereby optimizing network performance in response to user demand and environmental conditions.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

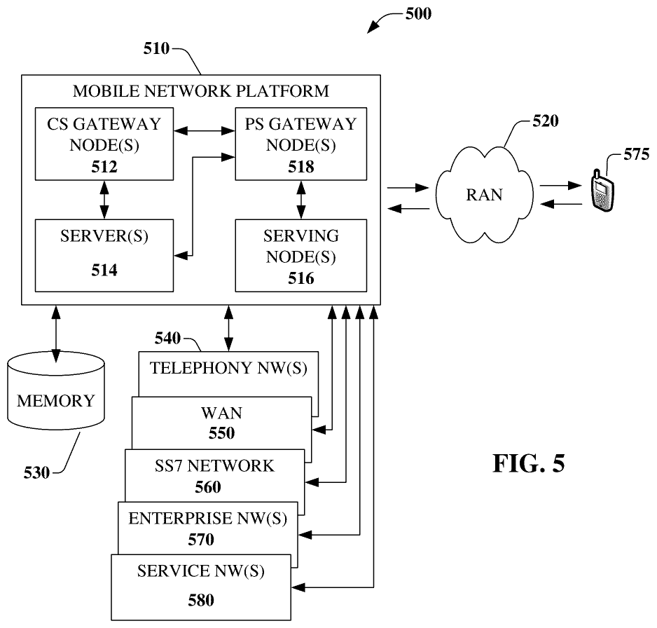

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part utilization of an elongated structure supporting a group of configurable electronic modules that are dynamically configurable by a module configuration generator to support dynamic network coverage and resource allocation to meet mobile service requirements, thereby optimizing network performance in response to user demand and environmental conditions. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7(SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc., that perform particular tasks and/or implement particular abstract data types.

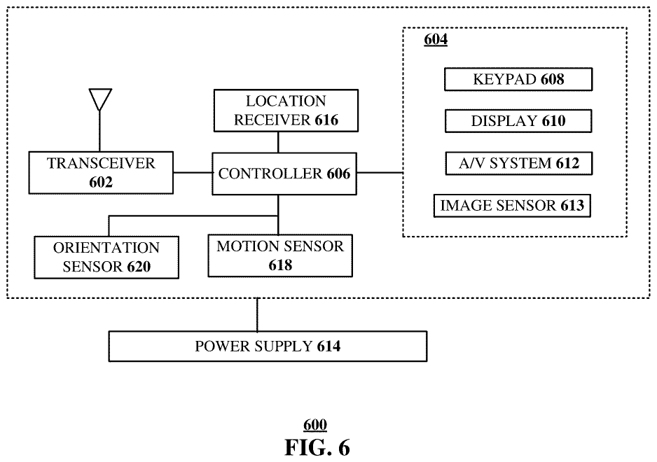

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part utilization of an elongated structure supporting a group of configurable electronic modules that are dynamically configurable by a module configuration generator to support dynamic network coverage and resource allocation to meet mobile service requirements, thereby optimizing network performance in response to user demand and environmental conditions.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth® . The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof. Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
an elongated module supporting structure;
a plurality of configurable electronic modules distributed along a length of the elongated module supporting structure;
a module configuration generator in communication with the plurality of configurable electronic modules and comprising a processing system including a processor; and
a memory that stores executable instructions thereon that, when executed by the processing system, cause the processing system to perform operations, the operations comprising:
determining a first mobile service requirement;
determining a first location along the length of the elongated module support structure according to the first mobile service requirement;
identifying a first electronic module subgroup of the plurality of configurable electronic modules according to the first location; and
configuring the first electronic module subgroup according to the first mobile service requirement.

2. The device of claim 1, wherein the plurality of configurable electronic modules comprise a plurality of configurable antenna modules.

3. The device of claim 2, wherein the plurality of configurable antenna modules are adapted to provide a localized wireless coverage substantially limited to a first sub-region proximate to a first location along the elongated module supporting structure and to an exclusion of other sub-regions proximate to other locations along the elongated module supporting structure.

4. The device of claim 3, wherein the antenna modules are operable in a millimeter wavelength region of the electromagnetic spectrum.

5. The device of claim 1, wherein the operations further comprise:
determining a first location of a wireless communication device, wherein the determining the first location along the length of the elongated module support structure is further according to the first location of the wireless communication device.

6. The device of claim 5, wherein the wireless communication device is a mobile communication device, the operations further comprising:
determining a second location of the wireless communication device, wherein the second location differs from the first location according to movement of the mobile communication device;
identifying a second electronic module subgroup of the plurality of configurable electronic modules according to the second location; and
configuring the second electronic module subgroup according to the first mobile service requirement.

7. The device of claim 1, wherein the operations further comprise:
determining a second mobile service requirement;
determining a second location along the length of the elongated module support structure according to the second mobile service requirement;
identifying a second electronic module subgroup of the plurality of configurable electronic modules according to the second location; and
configuring the second electronic module subgroup according to the first mobile service requirement.

8. The device of claim 7, wherein the first mobile service requirement comprises a communication subscriber requirement associated with a subscriber of a first wireless communication device proximate to the first location.

9. The device of claim 8, wherein the second mobile service requirement comprises a communication network requirement associated with a wireless communication network configured to provide communication services at the first location.

10. The device of claim 1, wherein the plurality of configurable electronic modules comprises a plurality of sensors configured to provide a sensor response according to a sensed condition, and wherein the first location is based on the sensor response.

11. The device of claim 1, wherein the operations further comprise:
determining a position of a mobile device, wherein the determining the first location along the length of the elongated module support structure is based on the position of the mobile device.

12. The device of claim 1, wherein the first mobile service requirement comprises a user plane function of a mobile communication network.

13. The device of claim 1, wherein the first mobile service requirement comprises a core function of a mobility core network of a wireless mobility network comprising a radio access network in communication with the mobility core network.

14. A method for providing dynamic network coverage and resource allocation, comprising:
determining, by a processing system including a processor, a first communication requirement;
locating, by the processing system, a first region along a length of an elongated module support structure comprising a plurality of configurable electronic modules, according to the first communication requirement;
selecting, by the processing system, a first electronic module subgroup of the plurality of configurable electronic modules according to the first region; and
configuring, by the processing system, the first electronic module subgroup according to the first communication requirement.

15. The method of claim 14, further comprising:
determining, by the processing system, a first location of a wireless communication device, wherein the locating the first region along the length of the elongated module support structure is further according to the first location of the wireless communication device.

16. The method of claim 15, wherein the wireless communication device is a mobile communication device, further comprising:
determining, by the processing system, a second location of the wireless communication device, wherein the second location differs from the first location according to movement of the mobile communication device;
selecting, by the processing system, a second electronic module subgroup of the plurality of configurable electronic modules according to the second location; and
configuring, by the processing system, the second electronic module subgroup according to the first communication requirement.

17. The method of claim 14, further comprising:
determining, by the processing system, a second communication requirement;
determining, by the processing system, a second location along the length of the elongated module support structure according to the second communication requirement;
identifying, by the processing system, a second electronic module subgroup of the plurality of configurable electronic modules according to the second location; and
configuring, by the processing system, the second electronic module subgroup according to the first communication requirement.

18. The method of claim 17, wherein the first communication requirement comprises a communication subscriber requirement associated with a subscriber of a first wireless communication device proximate to the first region along the length of the elongated module support structure.

19. A non-transitory machine-readable medium, comprising executable instructions that, when executed by a processing system including a processor, facilitate performance of operations, the operations comprising:
determining a communication requirement;
determining a first location along a length of an extended configurable processing system according to the communication requirement, wherein the extended configurable processing system comprises a physical support comprising a plurality of configurable modules coupled thereto;
identifying a first configurable module subgroup of the plurality of configurable modules according to the first location; and
configuring the first configurable module subgroup according to the communication requirement.

20. The non-transitory machine-readable medium of claim 19, wherein the operations further comprise:
determining a first location of a mobile communication device, wherein the determining the first location along the length of the extended configurable processing system is according to the first location of the mobile communication device;
detecting movement of the mobile communication device to a second location along the length of the extended configurable processing system that differs from the first location;
identifying a second configurable module subgroup of the plurality of configurable modules according to the second location; and
configuring, by the processing system, the first configurable module subgroup and the second configurable module subgroup according to the movement of the mobile communication device and the communication requirement.
